(19) United States
(12) Patent Application Publication
(10) Pub. No.: US 2025/0284575 A1
(43) Pub. Date: Sep. 11, 2025

(54) TOKEN-CONTROLLED STREAMING ORDERED WRITE IN DATA COMMUNICATION

(71) Applicant: QUALCOMM Incorporated, San Diego, CA (US)

(72) Inventors: Philippe BOUCARD, Le Chesnay (FR); Olivier LOISON, Sevres (FR); Nordine CHAIBELAINE, Rungis (FR); Ameline LE ROUZIC, Versailles (FR)

(21) Appl. No.: 18/601,373

(22) Filed: Mar. 11, 2024

(51) Int. Cl. G06F 9/54; G06F 13/16; G06F 13/40; G06F 15/78

(52) U.S. Cl. CPC G06F 9/546; G06F 13/1673; G06F 13/4022; G06F 15/7825

(57) ABSTRACT

Some aspects of the disclosure provide various techniques for ordered write (OW) transactions and operations in a data network, for example, a network-on-chip (NoC) in a system-on-chip. A streaming OW transaction can utilize a virtual channel in the data network to avoid deadlock in a multi-source and multi-destination system. Access to the virtual channel is facilitated by a token exchanged between a request node (RN) and a home node (HN) to ensure that the HN has available resources for received OW data from the RN.

### TECHNICAL FIELD

The technology discussed below relates generally to data communication systems, and in particular, ordered write operations in a multi-source and multi-destination data communication system.

### INTRODUCTION

A system-on-chip (SoC) is an integrated semiconductor device that can include a network-on-chip (NoC) for providing an on-chip communication infrastructure that acts as a scalable and efficient interconnection network for various function blocks, processor cores, and memory subsystems within the SoC. A NoC provides a data network that allows various components to exchange data, commands, and signals (e.g., control signals) efficiently in the SoC. However, the NoC needs to maintain data coherency and correct sequence of operations among the different components within the SoC, especially in multi-core and multi-cluster SoC architectures. In one example, the NoC can use a data communication protocol that can maintain data coherency and correct operations a multi-core and/or multi-cluster SoC.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

Various method, system, device, and apparatus embodiments may also include additional features. Some aspects of the disclosure provide various techniques for ordered write (OW) transactions and operations in a data network, for example, a network-on-chip (NoC) in a system-on-chip. A streaming OW transaction can utilize a virtual channel in the data network to avoid deadlock in a multi-source and multi-destination system. Access to the virtual channel is facilitated by a token exchanged between a request node (RN) and a home node (HN) to ensure that the HN has available resources for received OW data from the RN.

One aspect of the disclosure provides a device for data communication. The device includes: a data network, one or more home nodes, and a plurality of request nodes connected to the one or more home nodes via the data network. Each of the plurality of request nodes can be configured to send an ordered write (OW) request message. A first request node among the plurality of request nodes is configured to: send a first OW request message to a first home node among the one or more home nodes, the first OW request message configured to initiate OW communication between the first request node and the first home node using a token issued by the first home node, and receive a write response message from the first home node, the write response message comprising the token to indicate that the first home node is ready to receive write data from the first request node.

One aspect of the disclosure provides a method of data communication. The method includes: sending, from a first request node among a plurality of request nodes, a first ordered write (OW) request message to a first home node among one or more home nodes connected to the plurality of request nodes via a data network, the first OW request message configured to initiate OW communication between the first request node and the first home node using a token issued by the first home node; and receiving, at the first request node, a write response message from the first home node, the write response message comprising the token to indicate that the first home node is ready to receive write data from the first request node.

One aspect of the disclosure provides a device for data communication. The device includes: a data network, a plurality of request nodes, each of the plurality of request nodes configured to send an ordered write (OW) request; and a home node connected to the plurality of request nodes via the data network. The home node is configured to: receive a first OW request message from a first request node among the plurality of request nodes, the first OW request message configured to initiate OW communication between the first request node and the home node using a token issued by the home node; and send a write response message to the first request node, the write response message comprising the token to indicate that the home node is ready to receive write data from the first request node.

One aspect of the disclosure provides a method of data communication. The method includes: receiving, at a home node, an ordered write (OW) request message from a first request node among a plurality of request nodes connected to the home node via a data network, the OW request message configured to initiate OW communication between the first request node and the home node using a token issued by the home node; and sending, to the first request node, a write response message, the write response message comprising the token to indicate that the home node is ready to receive write data from the first request node.

These and other aspects of the present disclosure will become more fully understood upon a review of the detailed description, which follows. Other aspects, features, and implementations will become apparent to those of ordinary skill in the art, upon reviewing the following description of specific, exemplary implementations in conjunction with the accompanying figures. While features may be discussed relative to certain examples and figures below, all implementations can include one or more of the advantageous features discussed herein. In other words, while one or more implementations may be discussed as having certain advantageous features, one or more of such features may also be used in accordance with the various examples discussed herein. In a similar fashion, while examples may be discussed below as device, system, or method implementations, it should be understood that such examples can be implemented in various devices, systems, and methods.

### BRIEF DESCRIPTION OF THE DRAWINGS

FIG. 1 is a schematic block diagram illustrating an exemplary system-on-chip (SoC) according to some aspects of the disclosure.

FIG. 2 is a block diagram illustrating exemplary data communication between a request node and home nodes in a SoC according to some aspects of the disclosure.

FIG. 3 is a diagram illustrating a first example of ordered write transactions in a SoC according to some aspects of the disclosure.

FIG. 4 is a diagram illustrating a second example of ordered write transactions in a SoC according to some aspects of the disclosure.

FIG. 5 is a flow diagram illustrating a process for controlling token allocation at a request node (RN) according to some aspects of the disclosure.

FIG. 6 is a diagram illustrating another process for controlling token allocation at a RN according to some aspects of the disclosure.

FIG. 7 is a flow diagram illustrating a process for controlling token allocation used in OW transactions according to some aspects of the disclosure.

FIG. 8 is a flow diagram illustrating a process for controlling token allocation at a home node (HN) according to some aspects of the disclosure.

FIG. 9 is a block diagram illustrating an example of a hardware implementation for an apparatus according to some aspects of the disclosure.

FIG. 10 is a flow chart illustrating an exemplary process for data communication at a request node of a data network using a token according to some aspects of the disclosure.

FIG. 11 is a flow chart illustrating an exemplary process for data communication at a home node of a data network using a token according to some aspects of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of the disclosure will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, firmware, or any combination thereof. Whether such elements are implemented as hardware or software depends upon the particular application and design constraints imposed on the overall system.

Some aspects of the present disclosure provide various techniques for ordered write (OW) transactions and operations in a data network, for example, a network-on-chip (NoC) in a system-on-chip. A streaming OW transaction can utilize a virtual channel in the data network to avoid deadlock in a multi-source and multi-destination system. Access to the virtual channel is facilitated by a token exchanged between a request node (RN) and a home node (HN) to ensure that the HN has available resources for received OW data from the RN.

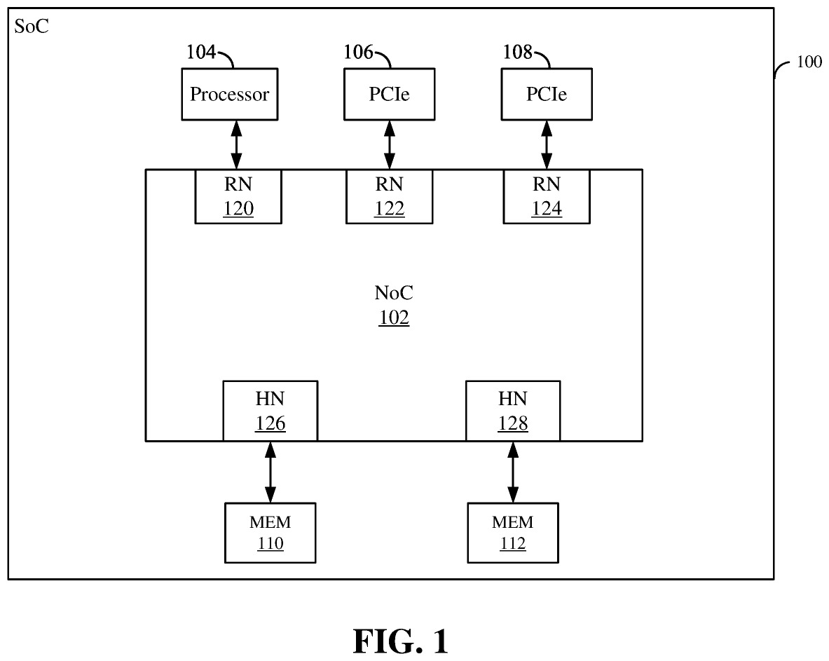

FIG. 1 is a schematic diagram of an exemplary system-on-chip (SoC) 100 according to some aspects of the present disclosure. The SoC 100 can be implemented as an integrated semiconductor device. The SoC 100 includes a network-on-chip (NoC) 102 that provides a data communication network for various function blocks, processor cores, and memory subsystems within the SoC 100. In some aspects, the SoC 100 can include one or more processors (e.g., shown as processor 104) and one or more peripheral component interconnect express (PCIe) controllers 106 and 108. For example, each of the PCIe controllers can be connected to one more PCIe peripheral devices (e.g., a root complex or an endpoint). The SoC 100 can further include one or more memory devices 110 and 112. For example, a memory device can include a memory controller connected to one or more memories or data storage devices (e.g., cache memory, dynamic random-access memory (DRAM), Flash memory, etc.). The NoC 102 enables data transfer and communication between the different components (e.g., processors 104, PCIe controllers 106 and 108, and/or memory devices 110 and 112) of the SoC.

The Noc 102 is configured to ensure that all processing cores (e.g., processor 104) and memories (e.g., cache memories 110 and 112) in the system have a consistent and synchronized view of data stored in the memories. This data coherence prevents data inconsistencies and ensures that the correct and most up-to-date data is always accessed or used, regardless of which core or memory is making the request. In the SoC 100, the NoC 102 can provide the physical connection for data transfer and communication between different components or functional blocks in the SoC, and a data coherency protocol can be used to manage how data is organized, controlled, and coherently shared among various components in the SoC. In some examples, the NoC 102 can include a coherent hub interface (CHI) network that implements the CHI protocol. The CHI protocol can classify different components in a system by node type and provides a means for communication between the nodes. For example, the CHI protocol is part of the Advanced Microcontroller Bus Architecture (AMBA) that is an open standard for the connection and management of functional blocks in a SoC. In other examples, the NoC 102 can be implemented using other network architectures, and it is not limited to the CHI protocol.

The NoC 102 can have various topologies, for example, a ring topology, a mesh topology, a crossbar interconnect, or other topologies. The data coherency protocol of the NoC 102 classifies different components in the SoC by node type and provides a means for data communication between the nodes. Examples of node types may include a request node (RN) and a home node (HN). A RN (e.g., RN 120, 122, or 124) can initiate a data transaction within the SoC 100. The RN is typically the source of a data request, such as a read or write operation. The RN can specify the details of the transaction, including the address, operation type, and the intended recipients of the data. The RN ensures that data is transferred and processed according to the specified operation and maintains data coherency requirements (e.g., ordered write). In this disclosure, an “ordered write” refers to a specific way of handling write operations to ensure data consistency in an SoC. For example, different components of the SoC might try to read or write to the same memory location. If these reads and writes are not carefully controlled and ordered, it could lead to inconsistencies in data. For example, in an OW transaction, a requester (e.g., RN) can require a sequence of write transactions to be observed in the same order as they are issued. Therefore, if the OW transactions are observed by other entities (e.g., other processors or other initiators) in the same order that the OW transactions are issued, “ordered write” is being observed in the system. An ordered write ensures that write operations are executed in a specific order for maintaining data integrity and consistency across different parts of the system. A HN (e.g., HN 126 or 128) is the target or destination of a data transaction initiated by the RN. The HN is responsible for receiving, processing, and responding to the requested transaction. The HN ensures that data is stored and managed appropriately. The HN plays a role in maintaining data coherency across caches and memory subsystems within the SoC. A component can be classified as a requester or completer. A requester is a component (e.g., RN) that starts a transaction by issuing a request message. A completer is a component (e.g. HN) that responds to a transaction received from another component.

In some aspects, the PCIe controllers 106 and 108 can be connected to respective RNs (e.g., RNs 122 and 124). In one example, the PCIe controller and the associated RN can be included in the same component or entity in the SoC 100. In some aspects, the memory devices 110 and 112 can be connected to respective HNs 126 and 128. In one example, memory devices 110 and 112 and their associated HNs 126 and 128 can be included in the same component or entity in the SoC 100. In the SoC, more than one RN (e.g., PCIe controllers 106 and 108) can send data to be written to the same HN (e.g., memory device 110). Therefore, deadlock may occur between the RNs that send data to the same HN. A deadlock is a situation in which the RNs are unable to send data to the same HN when each is waiting for the other to release resources or complete a task. In some examples, a deadlock may occur if there are dependencies between write operations that form a circular wait condition. For instance, a first RN can be waiting for a write operation by a second RN to complete before it can execute its own write operation. Simultaneously, the second RN can be waiting for a write operation by the first RN to complete. This situation leads to a deadlock since neither process can proceed.

In some aspects, the NoC 102 can support streaming ordered write (OW) transactions between RNs and HNs. Streaming OW (SOW) transactions follow ordered write observation (OWO) that guarantees the observation order by other agents or entities in the system (e.g., SoC 100), for a sequence of write transactions from a single agent (e.g., a single RN). In a OW transaction, when a requester (e.g., RN) requires a sequence of write transactions to be observed in the same order as they are issued, then the requester waits for completion of a write transaction before issuing the next write in the sequence. Such an observation is called an ordered write observation. In some aspects, SOW transactions can be further optimized. For example, if a previously sent write data is directed to a first target (e.g., HN), then the requester (e.g., RN) does not need to wait for a response from the first target for the request before sending the next ordered write to a different target (e.g., a different HN).

In some examples, a RN (e.g., a requester) can send write data to a HN (e.g., a completer) using OW operations. Using OW operations can ensure that data is written to the destination target (e.g., memory or shared resources or HN associated therewith) in a specific order. The OW operations can follow OWO to maintain data coherency, ensuring that multiple cores or clusters have a consistent view of memory and data. However, in some scenarios, the OW operations can experience bottlenecks or deadlocks when there are concurrent communication in the SoC or NoC.

Aspects of the present disclosure provide techniques for performing OW operations using a virtual channel and tokens between RNs and HN, to avoid communication deadlock and provide high performance in a data network, in particular, multi-source multi-destination architectures. Access to the virtual channel can be facilitated by a token passed between an RN and a HN. The techniques can improve the scalability of the CHI network that can enable communication between multiple data sources (e.g., PCIe controllers) and multiple data destinations (e.g., memory devices). The token-controlled channels can be used to guarantee forward progress of OW data towards the targeted HNs. In some aspects, a token exchange scheme is used between a RN and a HN to guarantee room in the HN available for the data sent from the RN.

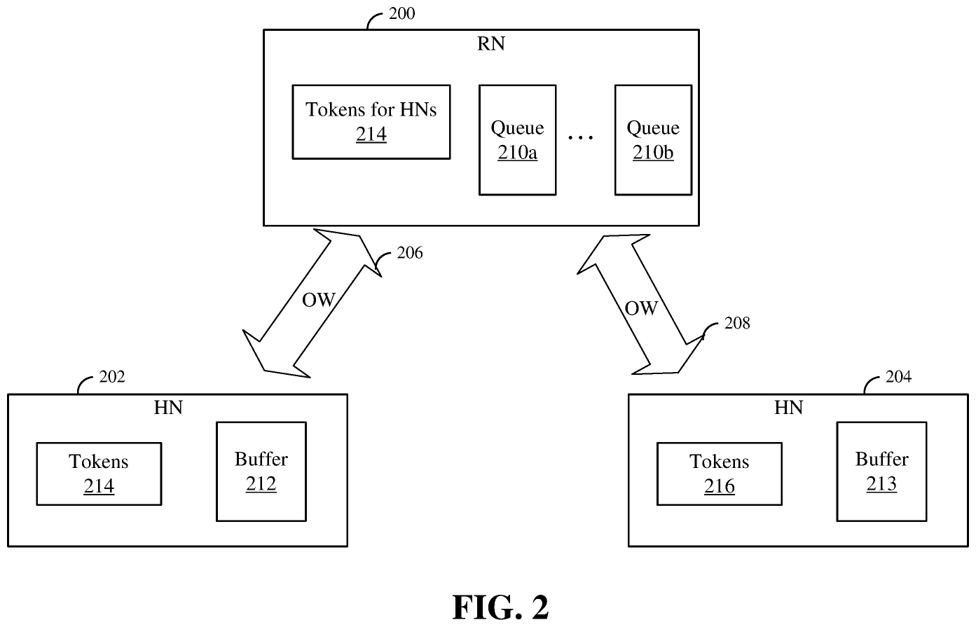

FIG. 2 is a block diagram illustrating exemplary data communication between a RN and HNs according to some aspects of the disclosure. In FIG. 2, a RN 200 can be any of the RNs in the SoC 100, and a HN (e.g., HNs 202 and 204) can be any of the HNs of the SoC 100. The RN 200 can communicate with the HNs using a NoC (e.g., NoC 102 of FIG. 1). In one example, the RN can send data to the HN using ordered write (OW) operations in a channel 206 or 208 and a token allocated by the HN. In some aspects, the RN 200 can include one or more queues (e.g., two queues 210a and 210b shown in FIG. 2) for storing or buffering the write data to be sent to the respective HNs. The RN 200 can use a separate queue (e.g., queues 210a, 210b) for each target HN. Each HN can include a buffer (e.g., buffers 212 and 213) for storing write data received from the RN. In some aspects, the OW operations between the RN 200 and HNs 202 and 204 are controlled using a token. Each HN can issue or allocate one or more tokens (e.g., tokens 214, 216) to the RN. The RN can then send write data to a HN (e.g., HN 204) using a virtual channel and the one or more tokens 216. When the RN receives data (e.g., data in queue 210a, 210b) that needs to be sent to a target HN, the RN confirms that at least one token has been received from that HN to proceed with sending the data. In some aspects, each RN has at least one token for each HN to which the RN needs to communicate with. In this disclosure, the token enables a virtual channel to be formed between an RN and a HN for OW transactions.

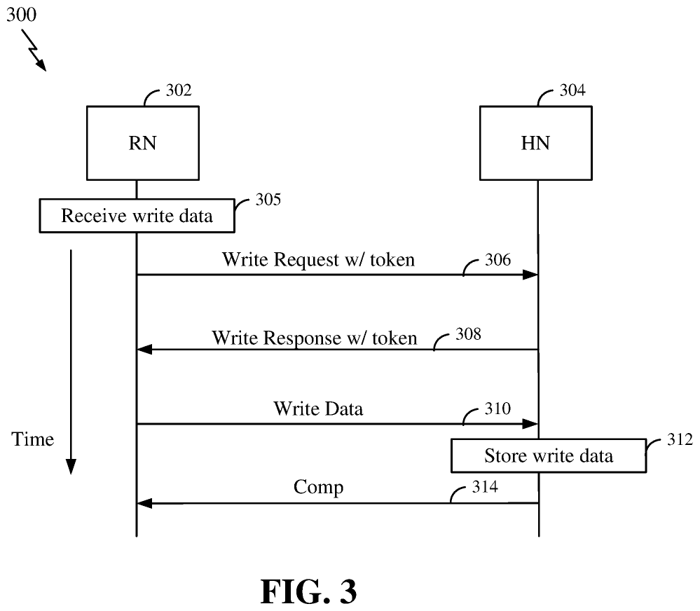

FIG. 3 is a diagram illustrating an example of ordered write (OW) transactions 300 using a virtual channel according to some aspects of the disclosure. In one example, the OW transactions 300 can be streaming OW transactions between a RN 302 (e.g., a PCIe device) and a HN 304 (e.g., a memory device 110 or 112). The RN 302 can receive write data from a PCIe device (e.g., PCIe controller 104, 106, or 108) to be sent to the HN. The HN 304 can receive the write data and store the write data to a memory device (e.g., memory device 110 or 112). The OW transactions or traffic can go through a NoC (e.g., NoC 102) that connects the RN with the HN. In FIG. 3, time is indicated vertically, from top to bottom. In other aspects, other connection protocols are also contemplated.

At 305, the RN 302 can receive write data to be sent to the HN 304. For example, the write data can be data received from a PCIe device (e.g., PCIe controller). In response, if the RN has at least one token allocated by the HN 304 (e.g., HN 202 of FIG. 2), the RN can send a write request message 306 with the token (e.g., token 214) to the HN over a virtual channel in the NoC. The write request message 306 indicates that the RN has OW data for the HN. In one example, the token may be included (e.g., piggybacked) in the write request message 306. The write request message 306 can include a bit field (e.g., one or more bits) that stores a value or identifier (e.g., token ID) corresponding to the token allocated by the HN. The HN can have a predetermined number N of tokens (e.g., token-1, token-2, . . . token-n) that can be allocated to the RN. The number of tokens available at a HN may be determined based on various factors, including for example, the available bandwidth (e.g., memory bandwidth) associated with the HN. The HN may have more tokens for allocation when the HN has more bandwidth. The HN can allocate one or more tokens to the RN. Without a token, the RN cannot send data to the HN. With more than one token, the RN can maintain more than one concurrent OW transaction with the same HN.

In response to receiving the write request message 306, the HN 304 can send a write response message 308 (e.g., DBID_Rsp) to the RN 302 over the virtual channel in the NoC. The write response message can indicate the data buffer identifiers for each write transaction. For example, the write response message 308 can include a data buffer identifier (DBID) that is associated with a certain data block or a portion of data that is being sent or written as part of the ordered write operation. The HN can assign a data buffer (e.g., buffer 212 or 213 in FIG. 2) associated with the DBID for receiving the write data from the RN. The HN can have a data buffer reserved for the token. Therefore, the token assures that the HN has available space or storage to receive the write data from the RN. The write response message 308 includes the same token that is included in the write request message 306. In other words, the HN 304 passes the token back to the RN 302 such that the OW data transaction occurs through a token-controlled channel (e.g., a private channel) between the RN and HN.

In response to receiving the write response message 308, the RN 302 can send write data 310 (Wr_Data) to the HN 304 using the DBID received in the write response message 308 . . . . With the token, the RN can send another OW request, if needed, to the HN. The RN cannot send the OW request to the HN without receiving the token back from the HN. In some aspects, the DBID can be used as a transaction ID for the write data, or a transaction ID can be derived from the DBID.

In response to receiving the write data 310, at 312, the HN 304 can send or store the data to a target memory device (e.g., a cache or DRAM) associated with the HN. Further, in response to receiving the write data 310, the HN 304 can send a write completion response message 314 (Comp or) to the RN. The write completion response message 314 indicates that the HN successfully received the write data. Using the above-described OW transactions, the RN can be assured that the HN has buffer space available for receiving the write data, thus avoiding potential deadlock in the NoC, in particular, when multiple sources (e.g., RNs) write data to the HN in different OW transactions.

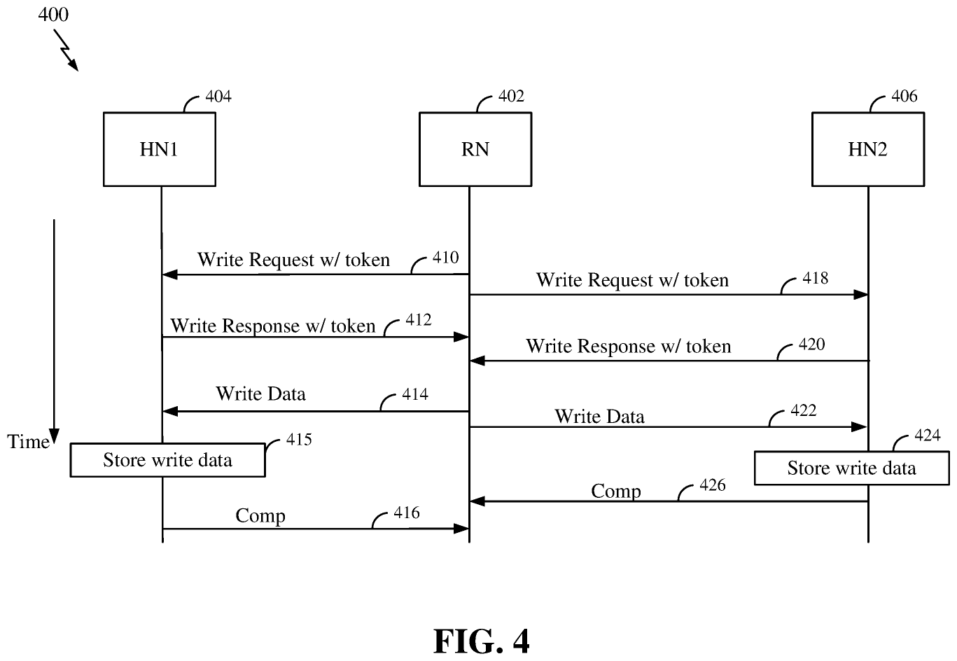

FIG. 4 is a diagram illustrating another example of OW transactions 400 using a virtual channel according to some aspects of the disclosure. In one example, the OW transactions 400 can be streaming OW transactions between a RN 402, a first HN 404 (HN1), and a second HN 406 (HN2). The OW transactions can go through a virtual channel in a NoC (e.g., NoC 102) that connects the RN 402 with the first HN 404 and second HN 406. In one example, the RN 402 can receive write data from a device (e.g., PCIe controller 106 or 108) to be sent to the first HN 404 or the second HN 406. In FIG. 4, time is indicated vertically, from top to bottom. In other aspects, other connection protocols are also contemplated.

The RN 402 can proceed with the OW transactions with the first HN 404 when the RN has a token allocated by the HN 404 even when the RN 402 has ongoing OW transactions with a different HN (e.g., second HN 406) that has allocated one or more tokens to the RN 402. In some aspects, the RN 402 has at least one token for each HN (e.g., RNs 404 and 406) so that the RN can start an OW transaction with each HN using a private channel. For example, when the RN 402 has a token allocated by the first HN 404, the RN can send a write request message 410 with the token to the HN 404 in order to initiate the OW transactions. The token may be piggybacked on the write request message 410. For example, the write request message 410 may include a bit field (e.g., one or more bits) that can store a value or identifier corresponding to the token. The first HN 404 can allocate one or more tokens to the RN 402. With the token, the RN can send OW data to the first HN 404 even when there are ongoing OW transactions with the second HN 406. In this way, the RN can communicate with the first HN 404 and the second HN 406 using respective private channels that are controlled using different tokens.

In response to receiving the write request message 410, the first HN 404 can send a write response message 412 (e.g., DBID_Rsp) with a token to the RN 402 over the private channel. The write response message can indicate the data buffer identifier (DBID) that is associated with a data block or a portion of data that is being transferred or written as part of the OW operation. The first HN 404 can assign a data buffer associated with the DBID for receiving the write data from the RN 402. The first HN 404 can have a data buffer reserved for each token allocated to the RN. Therefore, the token assures that the first HN 404 will have available space or data storage to receive the write data from the RN.

In response to receiving the write response message 412 with the token, the RN 402 can send write data 414 (Wr_Data) to the first HN 404 using the DBID received in the write response message 412. The DBID can be used as a transaction ID for the write data. In response to receiving the write data 414, at 415, the HN 404 can store the data to a target memory device (e.g., cache or DRAM) associated with the first HN 404.

Further, in response to receiving the write data 414, the first HN 404 can send a write completion response message 416 (Comp) to the RN. Using the above-described token-controlled OW transactions, the RN 402 can be assured that the HN 404 has buffer space available for receiving the write data, even when the RN 402 has ongoing OW transactions with other HNs (e.g., HN 406). For example, when the RN 402 has a token allocated by the second HN 406, the RN can send a write request message 418 with the token to the HN 406 in order to initiate the OW transactions. The token may be piggybacked on the write request message 418. For example, the write request message 418 may include a bit field (e.g., one or more bits) that can store a value or identifier corresponding to the token. The second HN 406 can allocate one or more tokens to the RN 402. With the token, the RN can send OW data to the second HN 406 using a private channel even when there are ongoing OW transactions with the first HN 404 in a different private channel.

In response to receiving the write request message 418, the second HN 406 can send a write response message 420 (e.g., DBID_Rsp) with a token to the RN 402 over the private channel. The write response message can indicate the DBID that is associated with a data block or a portion of data that is being transferred or written as part of the OW operation. The second HN 406 can assign a data buffer associated with the DBID for receiving the write data from the RN 402. The second HN 406 can have a data buffer reserved for each token allocated to the RN. Therefore, the token assures that the second HN 406 will have available space or data storage to receive the write data from the RN.

In response to receiving the write response message 420 with the token, the RN 402 can send write data 422 (Wr_Data) to the second HN 406 using the DBID received in the write response message 420. The DBID can be used as a transaction ID for the write data. In response to receiving the write data 422, at 424, the second HN 406 can store the data to a target memory device (e.g., cache or DRAM) associated with the first HN 406. Further, in response to receiving the write data 422, the second HN 406 can send a write completion response message 426 (Comp) to the RN.

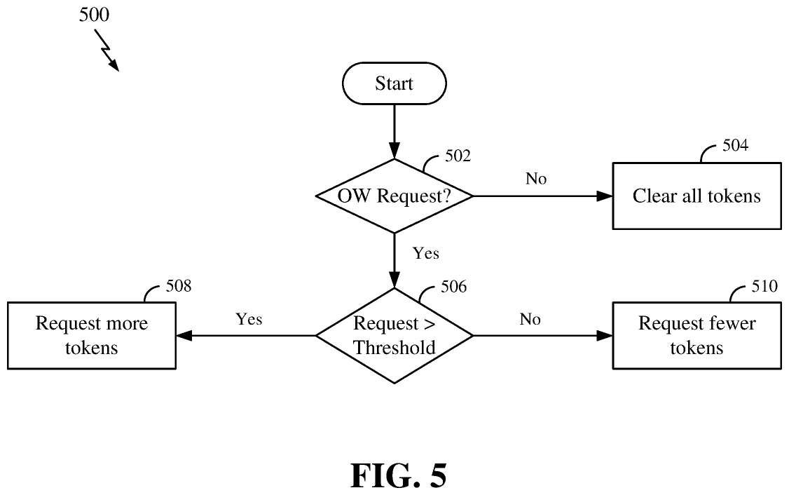

FIG. 5 is a flow diagram illustrating a process 500 for controlling token allocation according to some aspects of the disclosure. The process 500 can be performed at any RN or a requester in a SoC described above in relation to FIGS. 1-4. In some aspects, a RN can use the process 500 to request a HN to increase, decrease, and clear the token(s) allocated to the RN.

At 502, the RN (e.g., RN 402) can check whether or not a OW request is pending at the RN. A pending OW request indicates that the RN has data pending for transmission to the HN (e.g., HN 404). In some aspects, the RN can check one or more buffers or queues where a pending OW request or write data may be present. For example, the RN can have a data buffer or queue dedicated to store write data destined for the HN. At 504, when the RN finds no pending OW request for the HN, the RN can send a clear token request (e.g., clear all tokens) to the HN. In some aspects, the RN can send a clear token request to multiple HNs to which no OW request is pending. In response to the clear token request, the HN can deallocate (clear) the token assigned to the RN.

At 506, the RN can check whether or not the number of pending OW requests is greater than a predetermined threshold. For example, the predetermined threshold can be fifty percent (or any desired value or threshold) of available buffer space at the RN for buffering OW requests or data. At 508, when the number of pending OW requests is greater than the predetermined threshold, the RN can request the HN to allocate more tokens to the RN. More tokens enable the RN to have more concurrent OW transactions with the HN. At 510, when the number of pending OW requests is not greater than (e.g., the number of pending OW requests is less than) the predetermined threshold, the RN can request the HN to allocate fewer tokens to the RN.

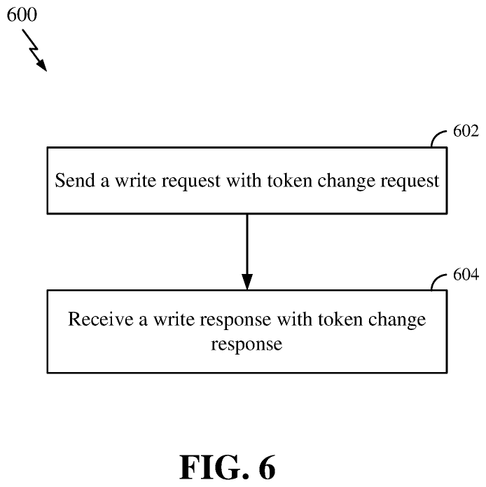

FIG. 6 is a diagram illustrating a process 600 for controlling token allocation at a RN according to some aspects of the disclosure. The process 600 can be performed at any RN or a requester described above in relation to FIGS. 1-4 or any suitable devices. In one example, a RN can use the process 600 in the process 500 (e.g., at block 508) to request more tokens. In one example, the RN can use the process 600 in the process 500 (e.g., at block 510) to request fewer tokens. In one example, the RN can use the process 600 in the process 500 (e.g., at block 504) to clear all tokens allocated to the RN.

At 602, the RN can send a write request message to a HN. For example, the write request message can be similar to the write request message 306 of FIG. 3. Further, the write request message can include (e.g., piggybacked) a token change request that requests the HN to increase, decrease, or clear the tokens allocated to the RN. For example, the token change request can include a flag or a bit field (e.g., one or more bits) that indicates a value that can cause the HN to make no change or change (e.g., increase or decrease) the tokens allocated to the RN. Further, the write request message can include (e.g., piggybacked) a token change request that requests the HN to clear all tokens allocated to the RN.

At block 604, the RN can receive a write response message from the HN. For example, the write response message can be similar to the write response message 308 (e.g., DBID_Rsp) of FIG. 3. The write response message can include (e.g., piggybacked) a token change response that increases, decreases, or clear the tokens allocated to the RN. In one aspect, when the HN grants a request to increase token allocation, the token change response can include a token ID of each additional token allocated to the RN. In one aspects, when the HN grants the request to decrease token allocation, the token change response can include a token ID of each token deallocated from the RN. In one aspects, when the HN grants a request to clear all tokens allocated to the RN, the token change response can include the token IDs of all token to be deallocated from the RN. In one aspect, the token change response can include a specific value that clears all token currently allocated to the RN.

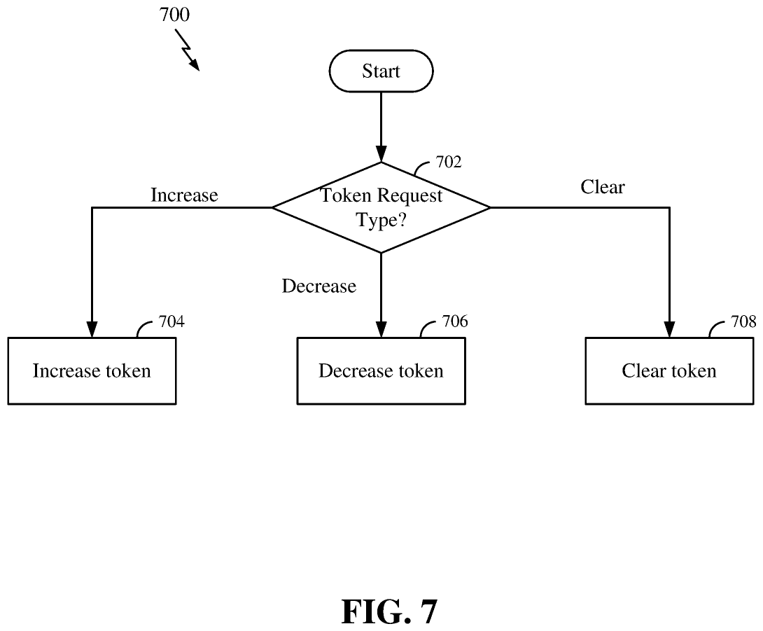

FIG. 7 is a flow diagram illustrating a process 700 for controlling token allocation used in OW transactions according to some aspects of the disclosure. The process 700 can be performed at any HN or a completer described above in relation to FIGS. 1-4, or any suitable devices. A HN can use the process 700 to response to a request from a RN to change (e.g., increase, decrease, and clear) the token(s) allocated to the RN.

At 702, the HN determines the type of a token change request received from a RN. The token change request can request the HN to increase, decrease, or clear the token allocation of the RN. In one example, the HN can receive the token change request piggybacked in a write request message 306 from the RN. The write request message 306 may have a field or flag that indicates the token change request and the type. At 704, based on the type of the token change request, the HN can send a message to the RN to increase the token allocation of the RN. For example, the message may include the token ID of the new token allocated to the RN. At 706, based on the type of the token change request, the HN can send a message to the RN to decrease the token allocation of the RN. In one example, the message may include the token ID of the token deallocated from the RN. At 708, based on the type of the token change request, the HN can send a message to the RN to clear all token allocation of the RN. In one example, the HN can send the message to increase, decrease or clear token allocation in a write response message 308 (e.g., DBID_Rsp).

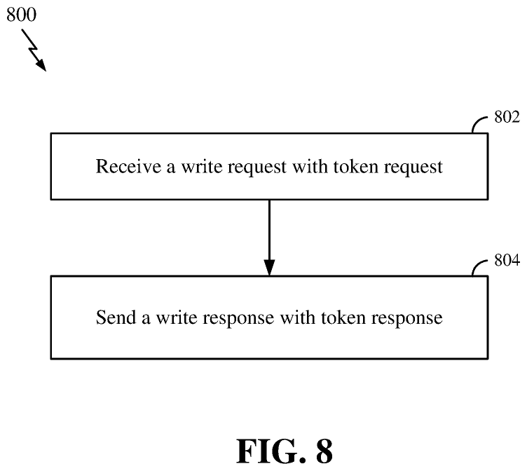

FIG. 8 is a diagram illustrating a process 800 for controlling token allocation at a HN according to some aspects of the disclosure. The process 800 can be performed at any HN or a completer described above in relation to FIGS. 1-4, or any suitable devices. In one example, the HN can use the process 800 in the process 700 (e.g., at block 704) to increase the token allocation of an RN. In one example, the HN can use the process 800 in the process 700 (e.g., at block 706) to decrease the token allocation of an RN. In one example, the HN can use the process 800 in the process 700 (e.g., at block 708) to clear all tokens allocated to a RN.

At 802, the HN can receive a write request message from a RN. For example, the write request message can be similar to the write request message 306 of FIG. 3. In one example, the write request message can include (e.g., piggybacked) a token change request that requests the HN to increase, decrease, or clear the tokens allocated to the RN. In one aspect, the token change request can include a flag or a bit field (e.g., one or more bits) that indicates a specific value that causes the HN to increase, decrease, or clear the token allocation of the RN. For example, a first value can cause the HN to increase token allocation, a second value can cause the HN to decrease token allocation, and a third value can cause the HN to clear all token allocation.

At block 804, the HN can send a write response message to the RN. For example, the write response message can be similar to the write response message 308 (e.g., DBID_Rsp) of FIG. 3. The write response message can include (e.g., piggybacked) a token change response that can increase, decrease, or clear the token allocation of the RN. In some aspects, the token change response can include a token ID of each token allocated to or deallocated from the RN. In some aspects, the token change response can include the token IDs of all tokens to be deallocated (cleared) from the RN. In one aspect, the token change response can include a specific value that clears all token allocated to the RN.

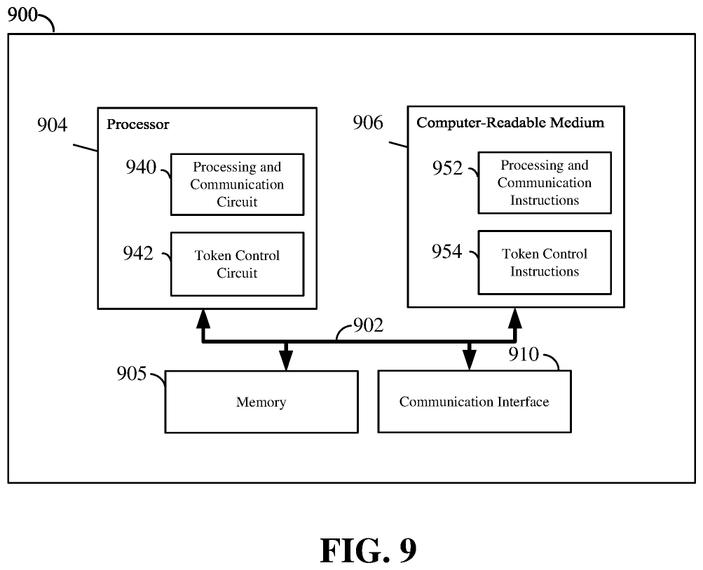

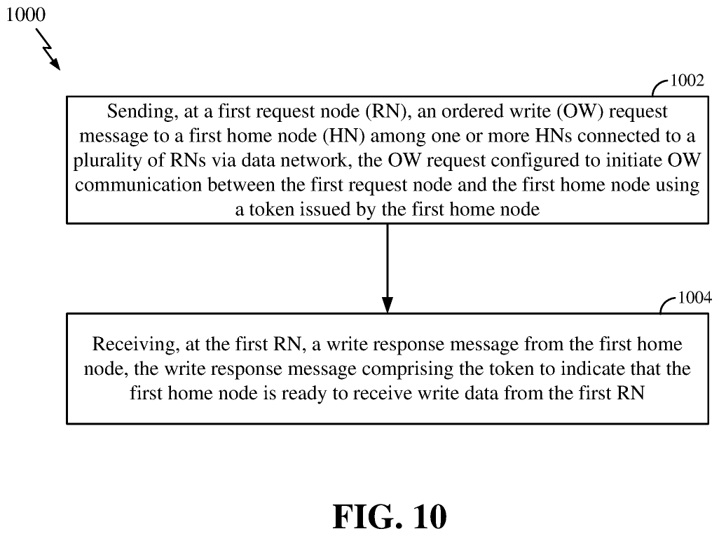

FIG. 9 is a block diagram illustrating an example of a hardware implementation for an apparatus 900. In one example, the apparatus 900 may be used to implement the SoC 100 or a portion of the SoC as illustrated in any one or more of FIGS. 1-4. The apparatus 900 may include one or more processors (e.g., processor 904), one or more memories (e.g., memory 905), a computer-readable medium 906. Examples of processors 904 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the apparatus 900 may be configured to perform any one or more of the functions described herein. In one example, the processor 904, as utilized in apparatus 900, may be used to implement any one or more of the processes and procedures described below and illustrated in FIG. 10.

In some aspects of the disclosure, the processor 904 may include processing and communication circuitry 940 configured for various functions, including for example communicating with a request node or home node via a data network (e.g., CHI network). In one or more examples, the computer-readable storage medium 906 may include software configured for various functions, including, for example, processing and communication instructions 952 that can configure the processing and communication circuitry to implement one or more of the functions described in relation to FIGS. 1-8 and 10.

In some examples, the processing and communication circuitry 940 may include one or more hardware components that provide the physical structure that performs processes related to data processing and communication (e.g., signal reception and/or signal transmission) and signal processing (e.g., processing a received signal and/or processing a signal for transmission). For example, the processing and communication circuitry 940 may include one or more transmit/receive chains. In addition, the processing and communication circuitry 940 may be configured to receive/send and process ordered write data. The processing and communication circuitry 940 may further be configured to execute processing and communication software 952 stored on the computer-readable medium 906 to implement one or more functions described herein.

In some implementations where the communication involves receiving information, the processing and communication circuitry 940 may obtain information from a component of the apparatus 900 (e.g., from a communication interface 910). For example, the processing and communication circuitry 940 may output the information to another component of the processor 904 (e.g., the memory 905, communication interface 910). In some examples, the processing and communication circuitry 940 may receive one or more of signals, messages, other information, or any combination thereof. In some examples, the processing and communication circuitry 940 may receive information via one or more channels. In some examples, the processing and communication circuitry 940 may include functionality for a means for receiving. In some examples, the processing and communication circuitry 940 may include functionality for a means for processing, including a means for demodulating, a means for decoding, etc.

In some implementations where the communication involves sending (e.g., transmitting) information, the processing and communication circuitry 940 may obtain information (e.g., from another component of the processor 904, the memory 905, or the communication interface 910), process (e.g., modulate, encode, etc.) the information, and output the processed information. For example, the processing and communication circuitry 940 may output the information to the communication interface 910 (e.g., that transmits the information via a NoC). In some examples, the processing and communication circuitry 940 may send one or more of signals, messages, other information, or any combination thereof. In some examples, the processing and communication circuitry 940 may send information via one or more channels. In some examples, the processing and communication circuitry 940 may include functionality for a means for sending (e.g., a means for transmitting). In some examples, the processing and communication circuitry 940 may include functionality for a means for generating, including a means for modulating, a means for encoding, etc.

The processor 904 is also responsible for general processing, including the execution of software stored on the computer-readable medium 906. The software, when executed by the processor 904, causes the apparatus 900 to perform the various functions described below for any particular apparatus. The computer-readable medium 906 and the memory 905 may also be used for storing data that is manipulated by the processor 904 when executing software.

One or more processors 904 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 906. The computer-readable computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 906 may reside in the apparatus 900, external to the apparatus 900, or distributed across multiple entities including the apparatus 900. The computer-readable medium 906 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

In some aspects of the disclosure, the processor 904 may include token control circuitry 942 configured for various functions, including, for example, controlling OW communication using a private channel and one or more tokens in a NoC (e.g., NoC 102 of FIG. 1). For example, the token control circuitry 942 may be configured to implement one or more of the functions described in relation to FIGS. 1-8 and 10 to control a private channel between a RN and a HN using tokens as described in relation to FIGS. 1-8. In one or more examples, the computer-readable storage medium 906 may include software configured for various functions, including, for example, token control instructions 954 that can configure the token control circuitry to implement one or more of the functions described in relation to FIGS. 1-8 and 10.

FIG. 10 is a flow chart illustrating an exemplary process 1000 for data communication at a request node using a token in accordance with some aspects of the present disclosure. As described below, some or all illustrated features may be omitted in a particular implementation within the scope of the present disclosure, and some illustrated features may not be required for implementation of all examples. In some examples, the process 1000 may be carried out by any RN illustrated in FIGS. 1-4. In some examples, the process 1000 may be carried out by any suitable apparatus or means for carrying out the functions or algorithm described below.

At block 1002, a first RN among a plurality of RNs can send an ordered write (OW) request message to a first HN among one or more HNs connected to the plurality of RNs via a data network (e.g., a coherent hub interface (CHI) network). The OW request message is configured to initiate OW communication between the first RN and the first HN using a token issued by the first HN. For example, the OW request message may be the write request message 306 of FIG. 3. For example, the data network can be the NoC 102 or any CHI network as described above. In one aspect, the first RN can receive write data from a device (e.g., PCI controller 106/108) to be sent to another device (e.g., memory device 110 or 112) via the data network. In one aspect, the processing and communication circuitry 940 and/or token control circuitry 942 can provide a means to send the OW request message.

At 1004, the first RN can receive a write response message from the first HN. The write response message includes the token to indicate that the first HN is ready to receive the write data from the first RN. For example, the write data may be streaming OW data. In one aspect, the processing and communication circuitry 940 and/or token control circuitry 942 can provide a means to receive the write response message. In one example, the write response message may be the write response message 308 of FIG. 3.

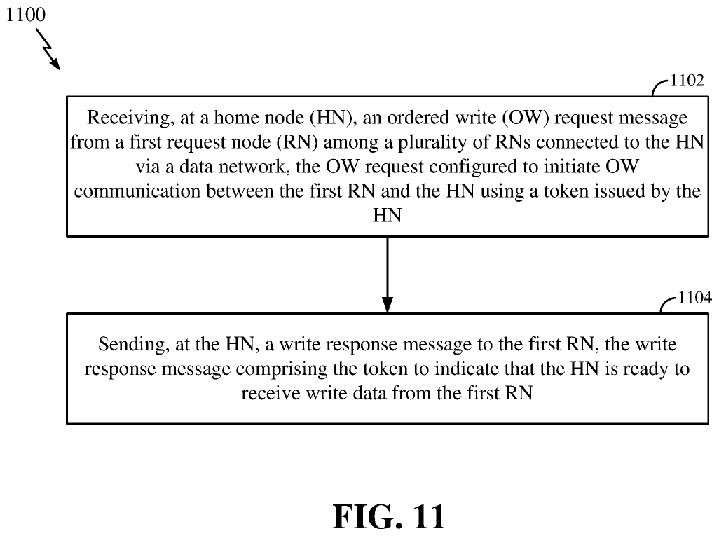

FIG. 11 is a flow chart illustrating an exemplary process 1100 for data communication at a home node (HN) using a token in accordance with some aspects of the present disclosure. As described below, some or all illustrated features may be omitted in a particular implementation within the scope of the present disclosure, and some illustrated features may not be required for implementation of all examples. In some examples, the process 1000 may be carried out by any HN illustrated in FIGS. 1-4. In some examples, the process 1000 may be carried out by any suitable apparatus or means for carrying out the functions or algorithm described below.

At block 1102, a HN can receive an ordered write (OW) request message from a first request node (RN) among a plurality of RNs connected to the home node via a data network (e.g., a CHI network). The OW request message is configured to initiate OW communication between the first RN and the HN using a token issued by the HN. For example, the OW request message may be the write request message 306 of FIG. 3. For example, the data network can be the NoC 102 or any CHI network as described above. In one aspect, the processing and communication circuitry 940 and/or token control circuitry 942 can provide a means to receive the OW request message.

At 1104, the HN can send a write response message to the first RN. The write response message includes the token to indicate that the HN is ready to receive the write data from the first RN. For example, the write data may be streaming OW data. In one aspect, the processing and communication circuitry 940 and/or token control circuitry 942 can provide a means to receive the write response message. In one example, the write response message may be the write response message 308 of FIG. 3.

In some aspects, the OW request message can include a token change request that is configured to at least one of: requesting the first home node to increase a token allocation of the first request node; requesting the first home node to decrease a token allocation of the first request node; or clearing a token allocation of the first request node. In one example, the token change request can request the first home node to make no change to the token allocation.

In some aspects, the first request node can determine a level of pending write request at the first request node, and the first request node can piggyback in the OW request message a request to increase a token allocation of the first request node in response to the level of pending write request being greater than a predetermined threshold.

In some aspects, the first request node can determine a level of pending write request at the first request node, and the request node can piggyback in the OW request message a request to decrease a token allocation of the request node in response to the level of pending write request being lower than a predetermined threshold.

In some aspects, the first request node can determine a level of pending write request at the request node, and the request node can piggyback in the OW request message a request to clear a token allocation of the request node in response to finding no pending write request at the request node.

In some aspects, the request node can send a OW request message to a second HN, irrespective of receiving the token back from the first home node.

In some aspects, the home node can grant a request to increase a token allocation to the RN, based on at least one of: an availability of one or more tokens at the home node; a priority level of the request node relative to another request node; or a level of OW communication in the data network.

Additional aspects of the disclosure are provided below as further examples.
Clause 1. A device for data communication, comprising:
a data network; one or more home nodes; and a plurality of request nodes connected to the one or more home nodes via the data network, each of the plurality of request nodes configured to send an ordered write (OW) request message, a first request node among the plurality of request nodes being configured to: send a first OW request message to a first home node among the one or more home nodes, the first OW request message configured to initiate OW communication between the first request node and the first home node using a token issued by the first home node, and receive a write response message from the first home node, the write response message comprising the token to indicate that the first home node is ready to receive write data from the first request node.
Clause 2. The device of clause 1, wherein the token is configured to reserve resources at the first home node for receiving the write data from the first request node.
Clause 3. The device of clause 1 or 2, wherein the first OW request message comprises a token change request that is configured to at least one of: request the first home node to increase a token allocation of the first request node; request the first home node to decrease a token allocation of the first request node; request the first home node to maintain a token allocation of the first request node; or clear a token allocation of the first request node.
Clause 4. The device of clause 1 or 2, wherein the first request node is further configured to: determine a level of pending write request at the first request node; and piggyback in the first OW request message a request to increase a token allocation of the first request node in response to the level of pending write request being greater than a predetermined threshold.
Clause 5. The device of clause 1 or 2, wherein the first request node is further configured to: determine a level of pending write request at the first request node; and piggyback in the first OW request message a request to decrease a token allocation of the first request node in response to the level of pending write request being lower than a predetermined threshold.
Clause 6. The device of clause 1 or 2, wherein the first request node is further configured to: determine a level of pending write request; and piggyback a request in the first OW request message to clear a token allocation of the first request node in response to finding no pending write request at the first request node.
Clause 7. The device of clause 1 or 2, wherein the first request node is further configured to: send a second OW request message to a second home node among the one or more home nodes, irrespective of receiving the token back from the first home node.
Clause 8. The device of clause 1 or 2, wherein the first request node is further configured to: send a second OW request message to a second home node among the one or more home nodes to initiate OW communication between the first request node and the second home node using a token issued by the second home node.
Clause 9. The device of clause 1 or 2, wherein the first request node is further configured to: send, to the first home node, a request to increase a token allocation to the first request node; and receive, from the first home node, a grant of the request to increase a token allocation to the first request node, based on at least one of: an availability of one or more tokens at the first home node; a priority level of the first request node relative to another request node of the plurality of request nodes; or a level of OW communication in the data network.
Clause 10. A method of data communication, comprising: sending, from a first request node among a plurality of request nodes, a first ordered write (OW) request message to a first home node among one or more home nodes connected to the plurality of request nodes via a data network, the first OW request message configured to initiate OW communication between the first request node and the first home node using a token issued by the first home node; and receiving, at the first request node, a write response message from the first home node, the write response message comprising the token to indicate that the first home node is ready to receive write data from the first request node.
Clause 11. The method of clause 10, wherein the token is associated with resources reserved at the first home node for receiving the write data from the first request node.
Clause 12. The method of clause 10 or 11, wherein the first OW request message comprises a token change request that is configured to at least one of: requesting the first home node to increase a token allocation of the first request node; requesting the first home node to decrease a token allocation of the first request node; or clearing a token allocation of the first request node.
Clause 13. The method of clause 10 or 11, further comprising: determining a level of pending write request at the first request node; and piggybacking in the first OW request message a request to increase a token allocation of the first request node in response to the level of pending write request being greater than a predetermined threshold.
Clause 14. The method of clause 10 or 11, further comprising: determining a level of pending write request at the first request node; and piggybacking in the first OW request message a request to decrease a token allocation of the first request node in response to the level of pending write request being lower than a predetermined threshold.
Clause 15. The method of clause 10 or 11, further comprising: determining a level of pending write request at the first request node; and piggybacking in the first OW request message a request to clear a token allocation of the first request node in response to finding no pending write request at the first request node.
Clause 16. The method of clause 10 or 11, further comprising: sending a second OW request message to a second home node among the one or more home nodes, irrespective of receiving the token back from the first home node.
Clause 17. The method of clause 10 or 11, further comprising: sending a second OW request message to a second home node among the one or more home nodes to initiate OW communication between the first request node and the second home node using a token issued by the second home node.
Clause 18. The method of clause 10 or 11, further comprising: sending, to the first home node, a request to increase a token allocation to the first request node; and receiving, from the first home node, a grant of the request to increase a token allocation to the first request node, based on at least one of: an availability of one or more tokens at the first home node; a priority level of the first request node relative to another request node of the plurality of request nodes; or a level of OW communication in the data network.
Clause 19. A device for data communication, comprising: a data network; a plurality of request nodes, each of the plurality of request nodes configured to send an ordered write (OW) request message; and a home node connected to the plurality of request nodes via the data network, the home node being configured to: receive a first OW request message from a first request node among the plurality of request nodes, the first OW request message configured to initiate OW communication between the first request node and the home node using a token issued by the home node, and send a write response message to the first request node, the write response message comprising the token to indicate that the home node is ready to receive write data from the first request node.
Clause 20. The device of clause 19, wherein the token is configured to reserve resources at the home node for receiving the write data from the first request node.
Clause 21. The device of clause 19 or 20, wherein the first OW request message comprises a token change request that is configured to at least one of: request the home node to increase a token allocation of the first request node; request the home node to decrease a token allocation of the first request node; request the home node to maintain a token allocation of the first request node; or clear a token allocation of the first request node.
Clause 22. The device of clause 19 or 20, wherein the home node is further configured to: receive, from the first request node, a request to increase a token allocation to the first request node; and transmit, to the first request node, a grant of the request to increase a token allocation to the first request node, based on at least one of: an availability of one or more tokens at the home node; a priority level of the first request node relative to another request node of the plurality of request nodes; or a level of OW communication in the data network.
Clause 23. The device of clause 19 or 20, wherein the home node is further configured to: receive, from the first request node, a request to decrease a token allocation to the first request node; and transmit, to the first request node, a grant of the request to decrease a token allocation to the first request node, based on at least one of: an availability of one or more tokens at the home node; a priority level of the first request node relative to another request node of the plurality of request nodes; or a level of OW communication in the data network.
Clause 24. A method of data communication, comprising: receiving, at a home node, an ordered write (OW) request message from a first request node among a plurality of request nodes connected to the home node via a data network, the OW request message configured to initiate OW communication between the first request node and the home node using a token issued by the home node; and sending, to the first request node, a write response message, the write response message comprising the token to indicate that the home node is ready to receive write data from the first request node.
Clause 25. The method of clause 24, further comprising: reserving resources associated with the token at the home node for receiving the write data from the first request node.
Clause 26. The method of clause 24, wherein the OW request message comprises a token change request that is configured to at least one of: Request the home node to increase a token allocation of the first request node; request the home node to decrease a token allocation of the first request node; request the home node to maintain a token allocation of the first request node; or clear a token allocation of the first request node.
Clause 27. The method of clause 24, further comprising: receiving, from the first request node, a request to increase a token allocation to the first request node; and transmitting, to the first request node, a grant of the request to increase a token allocation to the first request node, based on at least one of: an availability of one or more tokens at the home node; a priority level of the first request node relative to another request node of the plurality of request nodes; or a level of OW communication in the data network.
Clause 28. The method of clause 24, further comprising: receiving, from the first request node, a request to decrease a token allocation to the first request node; and transmit, to the first request node, a grant of the request to decrease a token allocation to the first request node, based on at least one of: an availability of one or more tokens at the home node; a priority level of the first request node relative to another request node of the plurality of request nodes; or a level of OW communication in the data network.

Several aspects of a data communication system have been presented with reference to an exemplary implementation. As those skilled in the art will readily appreciate, various aspects described throughout this disclosure may be extended to other data communication systems, network architectures and communication standards.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-11 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1-11 may be configured to perform one or more of the methods, features, or steps described herein. The novel algorithms described herein may also be efficiently implemented in software and/or embedded in hardware to improve data coherency in a system or SoC.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

What is claimed is:

1. A device for data communication, comprising:
a data network;
one or more home nodes; and
a plurality of request nodes connected to the one or more home nodes via the data network, each of the plurality of request nodes configured to send an ordered write (OW) request message,
a first request node among the plurality of request nodes being configured to:
send a first OW request message to a first home node among the one or more home nodes, the first OW request message configured to initiate OW communication between the first request node and the first home node using a token issued by the first home node, and
receive a write response message from the first home node, the write response message comprising the token to indicate that the first home node is ready to receive write data from the first request node.

2. The device of claim 1, wherein the token is configured to reserve resources at the first home node for receiving the write data from the first request node.

3. The device of claim 1, wherein the first OW request message comprises a token change request that is configured to at least one of:
request the first home node to increase a token allocation of the first request node;
request the first home node to decrease a token allocation of the first request node;
request the first home node to maintain a token allocation of the first request node; or
clear a token allocation of the first request node.

4. The device of claim 1, wherein the first request node is further configured to:
determine a level of pending write request at the first request node; and
piggyback in the first OW request message a request to increase a token allocation of the first request node in response to the level of pending write request being greater than a predetermined threshold.

5. The device of claim 1, wherein the first request node is further configured to:
determine a level of pending write request at the first request node; and
piggyback in the first OW request message a request to decrease a token allocation of the first request node in response to the level of pending write request being lower than a predetermined threshold.

6. The device of claim 1, wherein the first request node is further configured to:
determine a level of pending write request; and
piggyback a request in the first OW request message to clear a token allocation of the first request node in response to finding no pending write request at the first request node.

7. The device of claim 1, wherein the first request node is further configured to:
send a second OW request message to a second home node among the one or more home nodes, irrespective of receiving the token back from the first home node.

8. The device of claim 1, wherein the first request node is further configured to:
send a second OW request message to a second home node among the one or more home nodes to initiate OW communication between the first request node and the second home node using a token issued by the second home node.

9. The device of claim 1, wherein the first request node is further configured to:
send, to the first home node, a request to increase a token allocation to the first request node; and
receive, from the first home node, a grant of the request to increase a token allocation to the first request node, based on at least one of:
an availability of one or more tokens at the first home node;
a priority level of the first request node relative to another request node of the plurality of request nodes; or
a level of OW communication in the data network.

10. A method of data communication, comprising:
sending, from a first request node among a plurality of request nodes, a first ordered write (OW) request message to a first home node among one or more home nodes connected to the plurality of request nodes via a data network, the first OW request message configured to initiate OW communication between the first request node and the first home node using a token issued by the first home node; and
receiving, at the first request node, a write response message from the first home node, the write response message comprising the token to indicate that the first home node is ready to receive write data from the first request node.

11. The method of claim 10, wherein the token is associated with resources reserved at the first home node for receiving the write data from the first request node.

12. The method of claim 10, wherein the first OW request message comprises a token change request that is configured to at least one of:
requesting the first home node to increase a token allocation of the first request node;
requesting the first home node to decrease a token allocation of the first request node; or
clearing a token allocation of the first request node.

13. The method of claim 10, further comprising:
determining a level of pending write request at the first request node; and
piggybacking in the first OW request message a request to increase a token allocation of the first request node in response to the level of pending write request being greater than a predetermined threshold.

14. The method of claim 10, further comprising:
determining a level of pending write request at the first request node; and
piggybacking in the first OW request message a request to decrease a token allocation of the first request node in response to the level of pending write request being lower than a predetermined threshold.

15. The method of claim 10, further comprising:
determining a level of pending write request at the first request node; and
piggybacking in the first OW request message a request to clear a token allocation of the first request node in response to finding no pending write request at the first request node.

16. The method of claim 10, further comprising:
Sending a second OW request message to a second home node among the one or more home nodes, irrespective of receiving the token back from the first home node.

17. The method of claim 10, further comprising:
sending a second OW request message to a second home node among the one or more home nodes to initiate OW communication between the first request node and the second home node using a token issued by the second home node.

18. The method of claim 10, further comprising:
sending, to the first home node, a request to increase a token allocation to the first request node; and
receiving, from the first home node, a grant of the request to increase a token allocation to the first request node, based on at least one of:
an availability of one or more tokens at the first home node;
a priority level of the first request node relative to another request node of the plurality of request nodes; or
a level of OW communication in the data network.

19. A device for data communication, comprising:
a data network;
a plurality of request nodes, each of the plurality of request nodes configured to send an ordered write (OW) request message; and
a home node connected to the plurality of request nodes via the data network, the home node being configured to:
receive a first OW request message from a first request node among the plurality of request nodes, the first OW request message configured to initiate OW communication between the first request node and the home node using a token issued by the home node, and
send a write response message to the first request node, the write response message comprising the token to indicate that the home node is ready to receive write data from the first request node.

20. The device of claim 19, wherein the token is configured to reserve resources at the home node for receiving the write data from the first request node.

21. The device of claim 19, wherein the first OW request message comprises a token change request that is configured to at least one of:
request the home node to increase a token allocation of the first request node;
request the home node to decrease a token allocation of the first request node;
request the home node to maintain a token allocation of the first request node; or
clear a token allocation of the first request node.

22. The device of claim 19, wherein the home node is further configured to:
receive, from the first request node, a request to increase a token allocation to the first request node; and
transmit, to the first request node, a grant of the request to increase a token allocation to the first request node, based on at least one of:
an availability of one or more tokens at the home node;
a priority level of the first request node relative to another request node of the plurality of request nodes; or
a level of OW communication in the data network.

23. The device of claim 19, wherein the home node is further configured to:
receive, from the first request node, a request to decrease a token allocation to the first request node; and
transmit, to the first request node, a grant of the request to decrease a token allocation to the first request node, based on at least one of:
an availability of one or more tokens at the home node;
a priority level of the first request node relative to another request node of the plurality of request nodes; or
a level of OW communication in the data network.

24. A method of data communication, comprising:
receiving, at a home node, an ordered write (OW) request message from a first request node among a plurality of request nodes connected to the home node via a data network, the OW request message configured to initiate OW communication between the first request node and the home node using a token issued by the home node; and
sending, to the first request node, a write response message, the write response message comprising the token to indicate that the home node is ready to receive write data from the first request node.

25. The method of claim 24, further comprising:
reserving resources associated with the token at the home node for receiving the write data from the first request node.

26. The method of claim 24, wherein the OW request message comprises a token change request that is configured to at least one of:
Request the home node to increase a token allocation of the first request node;
request the home node to decrease a token allocation of the first request node;
request the home node to maintain a token allocation of the first request node; or
clear a token allocation of the first request node.

27. The method of claim 24, further comprising:
receiving, from the first request node, a request to increase a token allocation to the first request node; and
transmitting, to the first request node, a grant of the request to increase a token allocation to the first request node, based on at least one of:
an availability of one or more tokens at the home node;
a priority level of the first request node relative to another request node of the plurality of request nodes; or
a level of OW communication in the data network.

28. The method of claim 24, further comprising:
receiving, from the first request node, a request to decrease a token allocation to the first request node; and
transmit, to the first request node, a grant of the request to decrease a token allocation to the first request node, based on at least one of:
an availability of one or more tokens at the home node;
a priority level of the first request node relative to another request node of the plurality of request nodes; or
a level of OW communication in the data network.
